(19) United States
(12) Patent Application Publication
(10) Pub. No.: US 2023/0325185 A1
(43) Pub. Date: Oct. 12, 2023

(54) METHODS AND APPARATUS TO ACCELERATE MATRIX OPERATIONS USING DIRECT MEMORY ACCESS

(71) Applicant: Intel Corporation, Santa Clara, CA (US)

(72) Inventors: Jesmin Jahan Tithi, San Jose, CA (US); Fabio Checconi, Fremont, CA (US); Ahmed Helal, Santa Clara, CA (US); Fabrizio Petrini, Menlo Park, CA (US)

(21) Appl. No.: 18/194,252

(22) Filed: Mar. 31, 2023

(51) Int. Cl. G06F 9/30; G06F 12/08

(52) U.S. Cl. CPC G06F 9/3001; G06F 12/08; G06F 2213/28

(57) ABSTRACT

Systems, apparatus, articles of manufacture, and methods are disclosed for performance of sparse matrix time dense matrix operations. Example instructions cause programmable circuitry to control execution of the sparse matrix times dense matrix operation using a sparse matrix and a dense matrix stored in memory, and transmit a plurality of instructions to execute the sparse matrix times dense matrix operation to DMA engine circuitry, the plurality of instructions to cause DMA engine circuitry to create an output matrix in the memory, the creation of the output matrix in the memory performed without the programmable circuitry computing the output matrix.

### GOVERNMENT INTEREST STATEMENT

This invention was made with Government support under Agreement No. HR0011-17-3-0004, awarded by DARPA. The Government has certain rights in the invention.

### FIELD OF THE DISCLOSURE

This disclosure relates generally to machine learning and, more particularly, to methods and apparatus to accelerate matrix operations using Direct Memory Access.

### BACKGROUND

Many different computing applications utilize matrix operations to perform underlying calculations. For example, multiply and accumulate operations are frequently performed in artificial intelligence and/or machine learning settings. More efficient computation of matrix operations results in more performant machine learning models and/or artificial intelligence systems.

### BRIEF DESCRIPTION OF THE DRAWINGS

FIG. 1 is a diagram illustrating performance of a Sparse Matrix times Dense Matrix (SpMM) operation.

FIG. 2 is a block diagram of an example compute device in which compute circuitry may interact with direct memory access (DMA) engine circuitry.

FIG. 3 is a block diagram of an example implementation of the DMA engine circuitry of FIG. 2.

FIG. 4 is a flowchart representative of example machine readable instructions and/or example operations that may be executed, instantiated, and/or performed by example programmable circuitry to implement the DMA engine circuitry of FIGS. 2 and/or 3 to execute an initialization operation.

FIG. 5 is a flowchart representative of example machine readable instructions and/or example operations that may be executed, instantiated, and/or performed by example programmable circuitry to implement the DMA engine circuitry of FIGS. 2 and/or 3 to execute a copy operation.

FIG. 6 is a flowchart representative of example machine readable instructions and/or example operations that may be executed, instantiated, and/or performed by example programmable circuitry to implement the compute circuitry of FIG. 2 to perform an SpMM operation via the DMA engine circuitry of FIGS. 2 and/or 3.

FIG. 7 is an another flowchart representative of example machine readable instructions and/or example operations that may be executed, instantiated, and/or performed by example programmable circuitry to implement the compute circuitry of FIG. 2 to perform an SpMM operation of the DMA engine circuitry of FIGS. 2 and/or 3.

FIG. 8 is a flowchart representative of example machine readable instructions and/or example operations that may be executed, instantiated, and/or performed by example programmable circuitry to implement the compute circuitry of FIG. 2 to perform an SpMM operation via the DMA engine circuitry of FIGS. 2 and/or 3.

FIG. 9 is a flowchart representative of example machine readable instructions and/or example operations that may be executed, instantiated, and/or performed by example programmable circuitry to implement the DMA engine circuitry of FIGS. 2 and/or 3 to execute queued operations.

FIG. 10 is a graph illustrating example performance benefits of implementing SpMM operations using direct memory access.

FIG. 11 is a block diagram of an example processing platform including programmable circuitry structured to execute, instantiate, and/or perform the example machine readable instructions and/or perform the example operations of FIGS. 4, 5, 6, 7, 8, and/or 9 to implement the compute device of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 4, 5, 6, 7, 8, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Sparse Matrix times Dense Matrix (SpMM) is a fundamental linear algebra operation that appears in many critical domains, including computational fluid dynamics, graph analytics, large scale data analytics and artificial intelligence (AI) and/or machine learning (ML) applications.

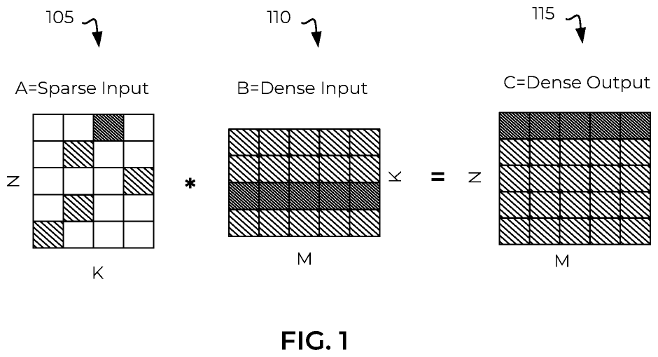

FIG. 1 is a diagram illustrating performance of a Sparse Matrix times Dense Matrix (SpMM) operation. As depicted in FIG. 1, SpMM generates a dense output matrix 115 of size N×M by multiplying a sparse matrix 105 of size N×K, often represented in CSR (compressed sparse row) or CSC (compressed sparse column) format, by a dense matrix 110 of size K×M. In some examples, the dimension N may be referred to as a first dimension, the dimension M may be referred to as a second dimension, and the dimension K may be referred to as a third dimension.

Because one of the inputs is sparse, the entire SpMM computation is irregular, memory intensive, and has poor locality. As a result, execution time is highly dependent on the sparsity pattern of the sparse input matrix (e.g., is dependent upon the input data). This makes obtaining high-performance for SpMM often challenging, which is exacerbated when scaling across multiple systems.

SpMM is heavily used in deep learning recommendation models (DLRM). Specifically, embedding layers, which map high-dimensional unstructured data into a low-dimensional continuous vector space, can be represented as SpMM operations. In DLRM models, the lookup indices of each input batch (e.g., the content of each row of the sparse matrix 105 in FIG. 1) are used to access large-scale embedding tables that keep learned dense vectors for certain categories (e.g., the dense matrix 110 of FIG. 1), and then these vectors are combined to produce the embedding output (e.g., the output matrix 115 of FIG. 1).

In practice, SpMM is one of the most time-consuming parts of DLRM because of the memory-intensive characteristics of the operation. Due to the increasing performance gap between computing cores and memory systems, addressing the memory-access bottleneck is a must since it enables better performance for SpMM, and as a result DLRM operations. Beyond DLRM, SpMM also constitutes a major portion of another popular AI model, graph neural network (˜80% of the total execution time). Examples disclosed utilize SpMM using Direct Memory Access (DMA) and/or Chained DMA Processing in the performance of SpMM operations. In some examples, such operations accelerate the performance of SpMM operations.

Direct memory access (DMA) is a feature of computer systems that enables components other than the central processing unit (CPU) to access main system memory. In other words, devices other than a CPU can operate upon data stored in the main memory independently of the CPU. Such an approach enables the CPU to perform other tasks, thereby resulting in more efficient operation of the overall computing system. In examples disclosed herein, DMA engine circuitry is used to perform SpMM operations on data stored in the main memory. SpMM is often a performance limiting kernel in many important applications. By performing SpMM using DMA, examples disclosed herein can improve the performance of the computing system significantly by reducing the burden of compute on the CPU cores who often need to wait for data to be accessed in the memory, since a large source of the delay of performing SpMM using a CPU is related to memory access.

Existing SpMM approaches suffer from a number of drawbacks. A traditional SpMM kernel, for example, that is to be executed by a traditional CPU-based and/or GPU-based architecture, issue memory access requests from the compute cores (e.g., the CPU or the GPU), where all data processing and output computing is to occur. For example, to implement a traditional SPMM, a CPU might iterate over rows of a sparse matrix, A, and for each non-zero column in that row, the CPU multiplies the column value with an entire row of the dense matrix, B. In doing so, the CPU must wait for data to be retrieved from the memory. Moreover, because many of the values in the sparse matrix are zero, a significant amount of time is wasted attempting to access non-informative data (if not represented in a sparse format). Even in sparse format, the access pattern is typically random, hence is not efficient in modern cache based system(s).

Example approaches disclosed herein utilize a memory-centric algorithm for SpMM operations to efficiently utilize memory bandwidth via chained DMA instructions.

DMA engine circuitry accelerates memory operations by accessing the main memory independently of the central processing unit (CPU). Example approaches disclosed herein enable such dedicated hardware to be exposed to programmers via specialized instructions.

In some examples disclosed herein, DMA chaining is utilized. DMA chaining allows multiple DMA instructions to follow strict sequential order without involving the CPU. In other words, a CPU need not provide DMA instructions one at a time, and instead, can provide DMA instructions to the DMA engine circuitry in a batched manner.

By chaining a sequence of memory heavy tasks, some examples disclosed herein leverage the use of DMA instructions not only to transfer and process large data chunks in one shot, but also to compute the output of memory bound SpMM operations (e.g., an embedding lookup operation) faster and more efficiently than other prior approaches.

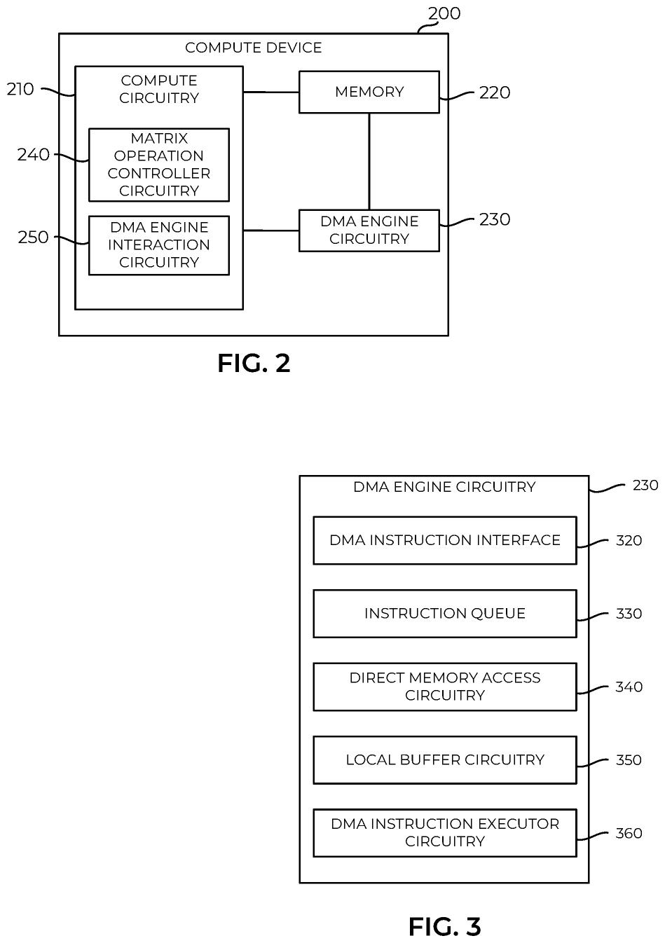

FIG. 2 is a block diagram of an example implementation of the compute device 200 of FIG. 1 to perform SpMM operations. The compute device 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the compute device 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The example compute circuitry 210 of the illustrated example of FIG. 2 implements matrix operation controller circuitry 240 and DMA engine interaction circuitry 250.

The example memory 220 of the illustrated example of FIG. 2 is implemented by any volatile memory, non-volatile memory, and/or mass storage device capable of storing information. In examples disclosed herein, the compute circuitry 210 accesses the memory 220 via a memory bus. Delays in accessing the memory 220 by the compute circuitry 210 contribute to slowness and/or inefficiencies in computation of SpMM operations when performed exclusively by the compute circuitry 210.

The example DMA engine circuitry 230 of the illustrated example of FIG. 2 performs SpMM operations using direct memory access into the example memory 220 at the direction of the compute circuitry 210. In the illustrated example of FIG. 2, a single instance of the DMA engine circuitry 230 is shown. However, in some examples, multiple instances of the DMA engine circuitry 230 may be utilized. Utilizing additional DMA engine circuitries enables additional direct memory operations to be performed in parallel, resulting in more efficient use of the memory and/or more timely completion of multiple DMA operations. In examples disclosed herein, the DMA engine circuitry 230 is capable of executing multiple DMA operations using DMA chaining. In some examples, this may be referred to as queuing. DMA chaining enables the compute circuitry 210 to provide (e.g., transmit, generate, etc.) a list of DMA operations (sometimes referred to as a batch, a set, a queue, etc.) to the DMA engine to be performed. In this manner, the compute circuitry 210 need not wait on completion of a first DMA operation before providing a second DMA operation to the DMA engine circuitry 230 for execution. A more detailed example implementation of the DMA engine circuitry 230 is disclosed in FIG. 3, below.

The example matrix operation controller circuitry 240 of the illustrated example of FIG. 2 controls the execution of matrix operations on data stored in the memory 220. In examples disclosed herein, such matrix operations on the data stored in the memory 220 are not performed by the matrix operation controller circuitry 240 or, more generally, the compute circuitry 210 accessing the memory 220 but, instead are performed by the DMA engine interaction circuitry 250 instructing the DMA engine circuitry 230 to perform such operations. In any event, the matrix operation controller circuitry 240 determines which operations are to be performed by the DMA engine circuitry 230, so that the DMA engine interaction circuitry 250 can provide those instructions to the DMA engine circuitry 230.

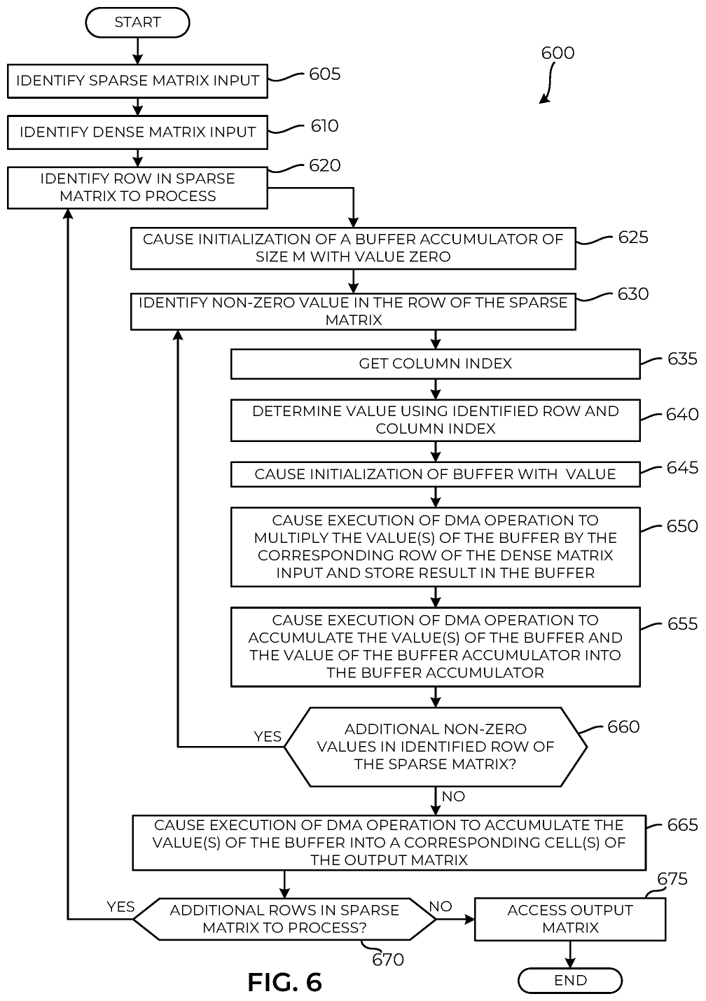

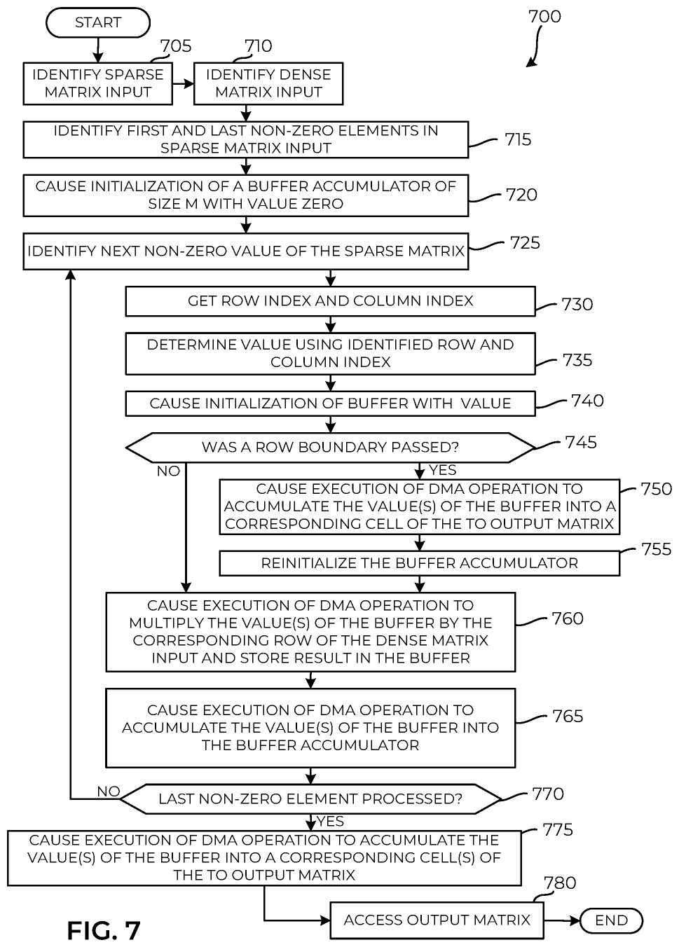

In some examples, the matrix operation controller circuitry 240 is instantiated by programmable circuitry executing matrix operation instructions and/or configured to perform operations such as those represented by the flowchart(s) of FIGS. 6, 7, and/or 8.

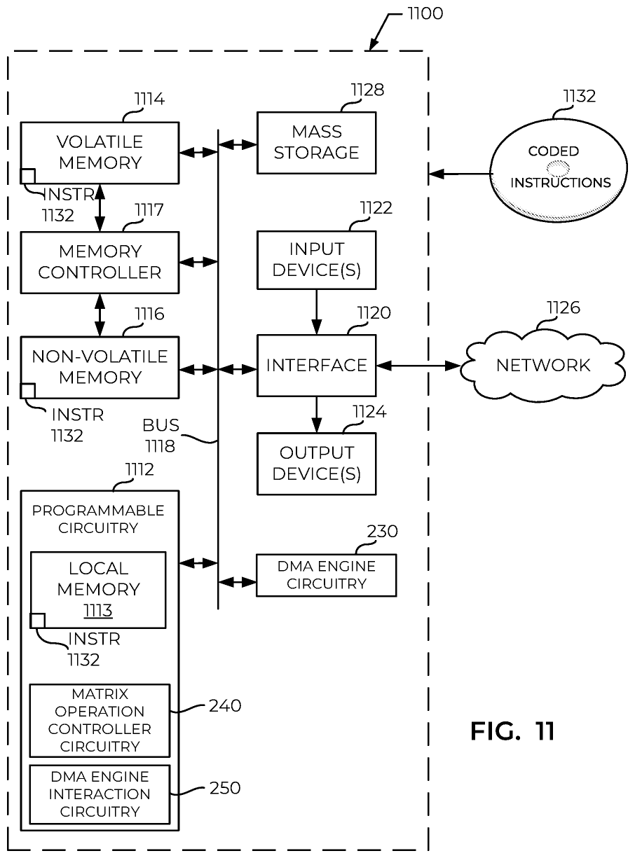

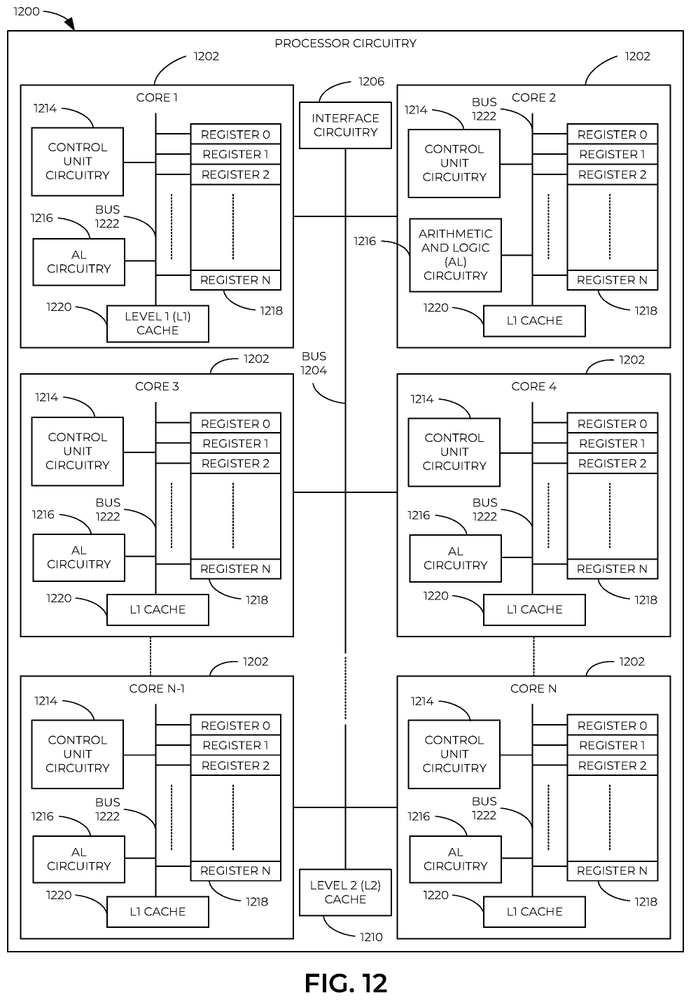

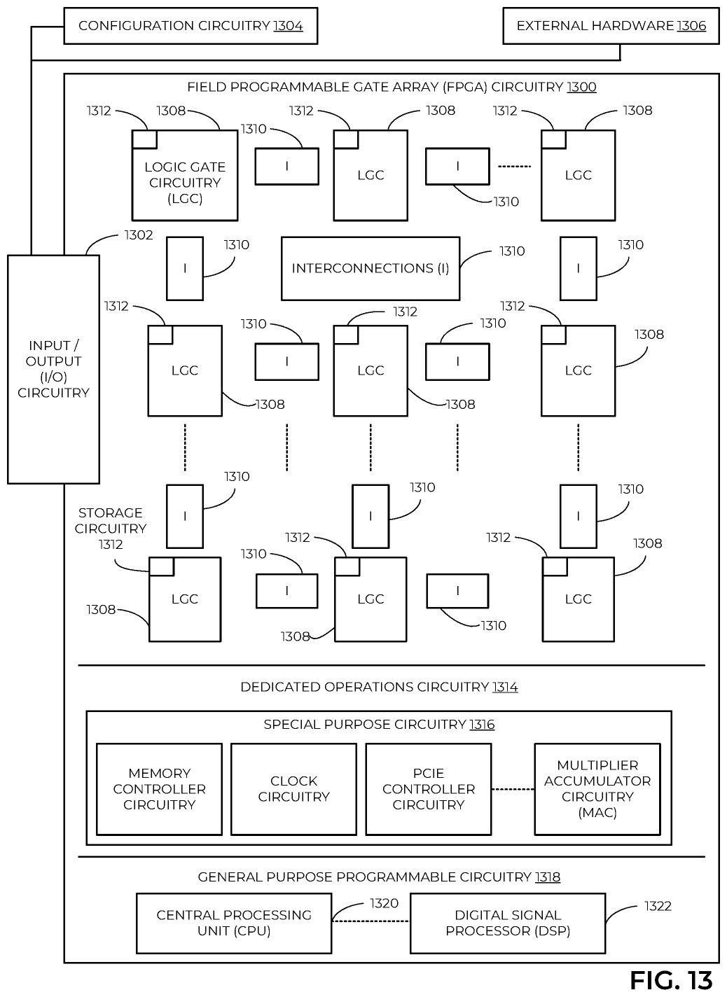

In some examples, the compute circuitry includes means for controlling. For example, the means for controlling may be implemented by matrix operation controller circuitry 240. In some examples, the matrix operation controller circuitry 240 may be instantiated by programmable circuitry such as the example programmable circuitry 1112 of FIG. 11. For instance, the matrix operation controller circuitry 240 may be instantiated by the example microprocessor 1200 of FIG. 12 executing machine executable instructions such as those implemented by at least blocks 605, 610, 620, 630, 635, 640, 660, 670, 675, 705, 710, 715, 725, 730, 735, 745, 770, 780, 805, 810, 815, 825, 830, 835, 845, 870, and/or 880 of FIGS. 6, 7, and/or 8. In some examples, the matrix operation controller circuitry 240 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the matrix operation controller circuitry 240 may be instantiated by any other combination of hardware, software, and/or firmware. For example, the matrix operation controller circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example DMA engine interaction circuitry 250 of the illustrated example of FIG. 2 interacts with the DMA engine circuitry 230 to provide (e.g., transmit, generate, etc.) instructions to the DMA engine circuitry 230 and/or receive information from the DMA engine circuitry 230. In some examples, the DMA engine interaction circuitry 250 is instantiated by programmable circuitry executing DMA engine interaction instructions and/or configured to perform operations such as those represented by the flowchart(s) of FIGS. 6, 7, and/or 8.

In some examples, the compute circuitry 210 includes means for interacting. For example, the means for interacting may be implemented by DMA engine interaction circuitry 250. In some examples, the DMA engine interaction circuitry 250 may be instantiated by programmable circuitry such as the example programmable circuitry 1112 of FIG. 11. For instance, the DMA engine interaction circuitry 250 may be instantiated by the example microprocessor 1200 of FIG. 12 executing machine executable instructions such as those implemented by at least blocks 625, 645, 650, 655, 665, 720, 740, 750, 755, 760, 765, 820, 840, 850, 855, 860, 865, 866, and/or 868 of FIGS. 6, 7, and/or 8. In some examples, the DMA engine interaction circuitry 250 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the DMA engine interaction circuitry 250 may be instantiated by any other combination of hardware, software, and/or firmware. For example, the DMA engine interaction circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the DMA engine circuitry 230 of FIG. 2. The DMA engine circuitry 230 of FIG. 3 may be instantiated (e.g., creating an instance of, bring into being for any length of time, materialize, implement, etc.) by programmable circuitry such as a Central Processor Unit (CPU) executing first instructions. In some examples, the DMA engine circuitry 230 may be implemented at a co-processor that is separate from a main CPU of the compute device 200. Additionally or alternatively, the DMA engine circuitry 230 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The example DMA engine circuitry 230 of the illustrated example of FIG. 3 includes a DMA instruction interface 320, an instruction queue 330, direct memory access circuitry 340, local buffer circuitry 350, and DMA instruction executor circuitry 360.

The example DMA instruction interface 320 of the illustrated example of FIG. 3 enables receipt of instructions from the DMA engine interaction circuitry 250. In some examples, the instructions cause the DMA engine circuitry 230 to immediately perform an operation (e.g., an initialization operation, a copy operation, etc.). However, in some other examples, the instructions cause the DMA engine circuitry 230 to queue execution of the operation. Upon completion of an operation and/or completion of execution of a queue, the DMA instruction interface 320 notifies the DMA engine interaction circuitry 250 of such completion.

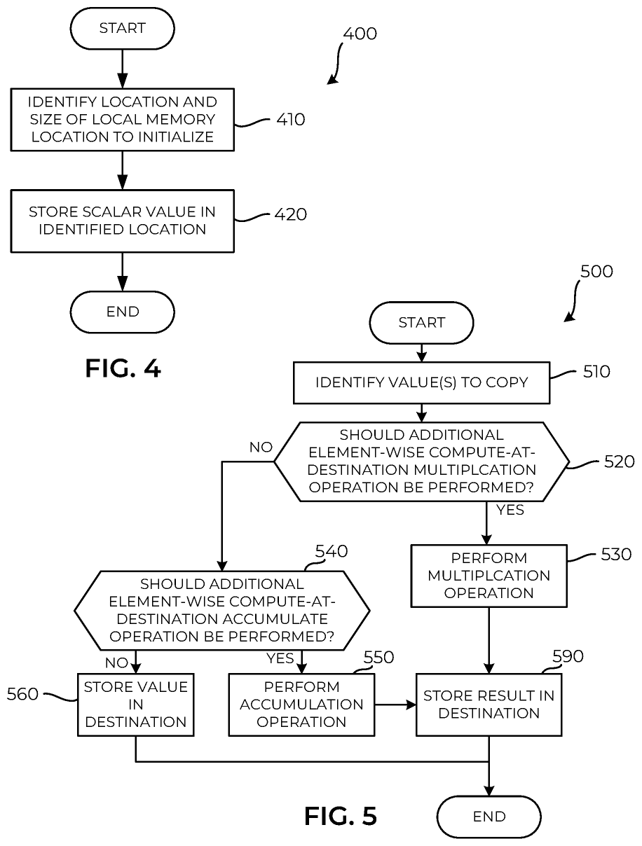

In some examples, the DMA instruction interface 320 is instantiated by programmable circuitry executing DMA instruction interface instructions and/or configured to perform operations such as those represented by the flowchart(s) of FIGS. 4, 5, and/or 9.

In some examples, the DMA engine circuitry 230 includes means for interfacing. For example, the means for interfacing may be implemented by DMA instruction interface 320. In some examples, the DMA instruction interface 320 may be instantiated by programmable circuitry such as the example programmable circuitry 1112 of FIG. 11. For instance, the DMA instruction interface 320 may be instantiated by the example microprocessor 1200 of FIG. 12 executing machine executable instructions such as those implemented by at least blocks 510 and/or 950 of FIGS. 5 and/or 9. In some examples, the DMA instruction interface 320 be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the DMA instruction interface 320 may be instantiated by any other combination of hardware, software, and/or firmware. For example, the DMA instruction interface 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example instruction queue 330 of the illustrated example of FIG. 3 is implemented by a memory capable of storing instructions to be executed. In some examples, the instruction queue 330 is implemented using a volatile memory. However, in other examples, the instruction queue 330 is implemented using a non-volatile memory. In some examples, the apparatus includes means for queuing. For example, the means for queuing may be implemented by the example instruction queue 330.

The example Direct Memory Access circuitry 340 of the illustrated example of FIG. 3 enables the DMA engine circuitry 230 to interface directly with the memory 220 via, for example, a bus. In this manner, the DMA circuitry 340 can access data stored in the memory 220 independently of the compute circuitry 210.

In some examples, the Direct Memory Access circuitry 340 is instantiated by programmable circuitry executing DMA instructions and/or configured to perform operations.

In some examples, the DMA engine circuitry 230 includes means for accessing. For example, the means for accessing may be implemented by Direct Memory Access circuitry 340. In some examples, the Direct Memory Access circuitry 340 may be instantiated by programmable circuitry such as the example programmable circuitry 1112 of FIG. 11. For instance, the Direct Memory Access circuitry 340 may be instantiated by the example microprocessor 1200 of FIG. 12 executing machine executable instructions. In some examples, the Direct Memory Access circuitry 340 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the Direct Memory Access circuitry 340 may be instantiated by any other combination of hardware, software, and/or firmware. For example, the Direct Memory Access circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example local buffer circuitry 350 of the illustrated example of FIG. 3 is implemented by a volatile memory such as, for example static random-access memory (SRAM), a scratchpad, or a cache. However, any other memory structure used for temporarily storing data may additionally or alternatively be used. In examples disclosed herein, the local buffer circuitry 350 stores a value of a buffer and a value of a buffer accumulator, both of which are used during execution of an SpMM operation. In some examples, the DMA engine circuitry 230 includes means for buffering. For example, the means for buffering may be implemented by the example local buffer circuitry 350.

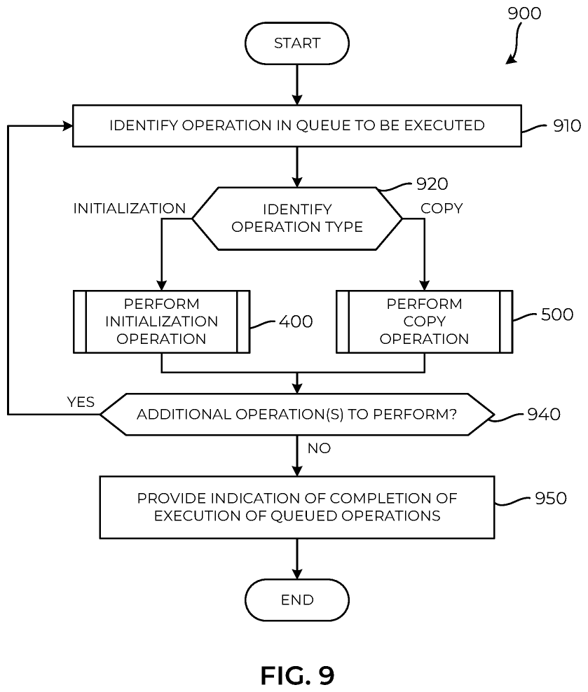

The example DMA instruction executor circuitry 360 of FIG. 3 executes instructions received via the DMA instruction interface 320 (e.g., at the direction of the DMA engine interaction circuitry 250 of FIG. 2). In some examples, the instructions cause the DMA instruction executor circuitry 360 to execute an initialization operation (disclosed in connection with FIG. 4, below). In some other examples, the instructions cause the DMA instruction executor circuitry 360 to execute a copy operation (disclosed in connection with FIG. 5, below). In some further examples, the DMA instruction executor circuitry 360 executes a queue instruction, which causes storage of an instruction to be executed in the instruction queue 330. Such queued instructions may later be executed by the DMA instruction executor circuitry 360 as disclosed in FIG. 9, below. To execute such DMA instructions, the DMA instruction executor circuitry 360 accesses the memory 220 using the direct memory access circuitry 340.

In some examples, the DMA instruction executor circuitry 360 is instantiated by programmable circuitry executing DMA instructions and/or configured to perform operations such as those represented by the flowchart(s) of FIGS. 4, 5, and/or 9.

In some examples, the apparatus includes means for executing. For example, the means for executing may be implemented by DMA instruction executor circuitry 360. In some examples, the DMA instruction executor circuitry 360 may be instantiated by programmable circuitry such as the example programmable circuitry 1112 of FIG. 11. For instance, the DMA instruction executor circuitry 360 may be instantiated by the example microprocessor 1200 of FIG. 12 executing machine executable instructions such as those implemented by at least blocks 410, 420, 520, 530, 540, 550, 560, 590, 910, 920, and/or 940 FIGS. 4, 5, and/or 9. In some examples, the DMA instruction executor circuitry 360 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the DMA instruction executor circuitry 360 may be instantiated by any other combination of hardware, software, and/or firmware. For example, the DMA instruction executor circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compute device 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the matrix operation controller circuitry 240, the example DMA engine interaction circuitry 250, and/or, more generally, the example compute circuitry 210 of FIG. 2, may be implemented by hardware alone or by hardware in combination with software and/or firmware. Thus, for example, any of the matrix operation controller circuitry 240, the example DMA engine interaction circuitry 250, and/or, more generally, the example compute circuitry 210 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compute circuitry 210 of FIG. 2 may include one or more elements, processes, and/or devices in addition to, or instead of, those illustrated in FIG. 2, and/or may include more than one of any or all of the illustrated elements, processes and devices.

Moreover, while an example manner of implementing the DMA engine circuitry 230 of FIG. 2 is illustrated in FIG. 3, one or more of the elements, processes, and/or devices illustrated in FIG. 3 may be combined, divided, re-arranged, omitted, eliminated, and/or implemented in any other way. Further, the example DMA instruction interface 320, the example instruction queue 330, the example direct memory access circuitry 350, the example local buffer circuitry 350, the example DMA instruction executor circuitry 360 and/or, more generally, the example DMA engine circuitry 230 of FIG. 3, may be implemented by hardware alone or by hardware in combination with software and/or firmware. Thus, for example, any of the example DMA instruction interface 320, the example instruction queue 330, the example direct memory access circuitry 350, the example local buffer circuitry 350, the example DMA instruction executor circuitry 360 and/or, more generally, the example DMA engine circuitry 230 of FIG. 3, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example DMA engine circuitry 230 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the compute device 200 of FIG. 2 and/or representative of example operations which may be performed by programmable circuitry to implement and/or instantiate the compute device 200 of FIG. 2, are shown in FIGS. 4, 5, 6, 7, 8, and/or 9. The machine readable instructions may be one or more executable programs or portion(s) of one or more executable programs for execution by programmable circuitry such as the processor circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 5, 6, 7, 8, and/or 9, many other methods of implementing the example compute device 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4, 5, 6, 7, 8, and/or 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

In examples disclosed herein, the DMA engine circuitry 230 performs two primary DMA operations: an initialization operation (described in FIG. 4), and a copy operation (described in FIG. 5). These DMA instructions, in one sense, are a type of vector instructions operating directly on memory resident data. The initialization operation initializes multiple elements at a memory location based on provided count and a provided scalar value. The copy operation moves multiple elements (corresponding to a provided count) from a first location in memory to a second location in memory. In some examples, additional flags may be provided as part of the copy operation to instruct the DMA engine circuitry 230 to perform element-wise compute at-destination operations. In examples disclosed herein, an addition operation and a multiplication operation are utilized to enable performance of a “multiply and accumulate,” which is typically performed in AI and/or ML settings.

FIG. 4 is a flowchart representative of example machine readable instructions and/or example operations 400 that may be executed, instantiated, and/or performed by programmable circuitry to perform an initialization operation. The example machine-readable instructions and/or the example operations 400 of FIG. 4 begin at block 410, at which the DMA instruction interface 320 identifies a location and a size of local memory to initialize (e.g., the local buffer circuitry 350). Typically, the location and size of the local memory to be initialized is provided as part of an instruction to the DMA engine circuitry 230 by the DMA engine interaction circuitry 250.

When the DMA instruction interface 320 identifies the location and size of the local memory, the DMA instruction executor circuitry 360 stores a scalar value in the identified location (e.g., in the local buffer circuitry 350). (Block 420). The local buffer circuitry 350, in some examples, is used to accumulate intermediate results of an SpMM operation. This temporary storage can be allocated/accessed as a local storage (e.g., SRAM, scratchpad, or cache), and results can be later written back to a main memory.

FIG. 5 is a flowchart representative of example machine readable instructions and/or example operations 500 that may be executed, instantiated, and/or performed by programmable circuitry to perform a copy operation. The example machine-readable instructions and/or the example operations 500 of FIG. 5 begin at block 510, at which the DMA instruction interface 320 identifies at least one value in a buffer to copy. The value may be identified as part of an instruction (e.g., function call) provided to the DMA engine circuitry 230 by the DMA engine interaction circuitry 250. In some examples, the copy may be performed on multiple values at the same time.

Once the values are identified for the copy operation, the DMA instruction executor circuitry 360 determines whether additional element-wise compute-at-destination multiplication operation(s) are to be performed. (Block 520). In some examples, the determination of whether to perform the element-wise compute-at-destination multiplication operation(s) is determined based on a flag and/or other indicator provided in the instruction to perform the copy operation.

When the DMA instruction executor circuitry 360 determines that additional element-wise compute-at-destination multiplication operations are to be performed (e.g., block 520 returns a result of YES), the DMA instruction executor circuitry 360 performs the multiplication operation. (Block 530). The DMA instruction executor circuitry 360 then stores the result of the multiplication operation in the destination. (Block 590).

When the DMA instruction executor circuitry 360 determines that no additional element-wise compute-at-destination multiplication operations are to be performed (e.g., block 520 returns a result of NO), the DMA instruction executor circuitry 360 determines whether additional element-wise compute-at-destination accumulate operations are to be performed. (Block 540). In some examples, the determination of whether to perform the element-wise compute-at-destination accumulation operation(s) is determined based on a flag and/or other indicator provided in the instruction to perform the copy operation. The DMA instruction executor circuitry 360 then stores the result of the accumulation operation in the destination. (Block 590).

When the DMA instruction executor circuitry 360 determines that no additional element-wise compute-at-destination accumulate operations are to be performed (e.g., block 540 returns a result of NO), the DMA instruction executor circuitry 360 stores the values identified in the destination. (Block 560).

Once the value has been stored in the destination or when the result of the multiplication operation or the accumulation operation has been stored in the destination, the example machine-readable instructions and/or the example operations 500 of FIG. 5 ends.

FIG. 6 is a flowchart representative of example machine readable instructions and/or example operations 600 that may be executed, instantiated, and/or performed by programmable circuitry to perform an SpMM operation. The example machine-readable instructions and/or the example operations 600 of FIG. 6 begin at block 605, at which the matrix operation controller circuitry 240 identifies a sparse matrix input (e.g., the sparse matrix 105). In some examples, the sparse matrix 105 has a size of N×K.

Once the matrix operation controller circuitry 240 identifies the sparse matrix input, the matrix operation controller circuitry 240 then identifies a dense matrix input (e.g., the dense matrix 110). (Block 610). In some examples, the dense matrix 110 has a size of K×M.

Once the matrix operation controller circuitry 240 identifies the sparse matrix 105 and the dense matrix 110, the matrix operation controller circuitry 240 identifies a row in the sparse matrix 105 to process. (Block 620).

Using the identified row, the DMA engine interaction circuitry 250 causes initialization of a buffer accumulator. (Block 625). The initialization is caused by the DMA engine interaction circuitry 250 providing an instruction to the DMA engine circuitry (e.g., a DMA initialize instruction), which then implements the initialization procedure disclosed in connection with FIG. 4. In examples disclosed herein, the buffer accumulator is implemented using the local buffer circuitry 350 of the DMA engine circuitry 230. In some examples, the buffer accumulator has a size of M with a value of zero. In some examples, the size of M is equal to the number of elements of the dense matrix 110 in a second dimension. In some examples, the buffer accumulator is populated with intermediate results (e.g., incremental throughout the SpMM operation) and can be allocated/accessed as a local storage (e.g., SRAM, scratchpad, cache, etc.).

The matrix operation controller circuitry 240 then identifies non-zero values in the identified row of the sparse matrix 105. (Block 630). In the examples disclosed herein, the SpMM operation is executed on index values that are non-zero. The matrix operation controller circuitry 240 determines a column index of the identified non-zero value. (Block 635). The matrix operation controller circuitry 240 then determines the value of the index to be manipulated using the identified row and column index. (Block 640). The DMA engine interaction circuitry 250 then causes initialization of a buffer with the value of the index to be manipulated. (Block 645). In some examples, instead of having the matrix operation controller circuitry 240 determine the value of the index to be manipulated, the DMA engine interaction circuitry 250 causes initialization of the buffer using the location at which the value is stored (e.g., causing the DMA engine circuitry 230 to read the value from the memory rather than providing the value to the DMA engine circuitry 230). In examples disclosed herein, the matrix operation controller circuitry 240 causes initialization of the buffer by sending an initialize instruction to the DMA engine circuitry 230, which then implements the initialization procedure disclosed in connection with FIG. 4.

The DMA engine interaction circuitry 250 then causes execution of a DMA operation to multiply the value(s) of the buffer with the corresponding row of the dense matrix 110. (Block 650). In some examples, the DMA engine interaction circuitry 250 provides a copy instruction to the DMA engine circuitry 230 with a flag set indicating that multiplication is to be performed while performing the copy operation. In response, the DMA engine circuitry 230 performs the requested copy (and multiply) operation according to the process disclosed in connection with FIG. 5, above. In some examples, the execution of the DMA operation multiplies the value of the buffer with a corresponding row of the dense matrix 110. In some examples, the result of the DMA operation is stored in the buffer.

Upon completion of the execution of the DMA operation to multiply the value(s) of the buffer with the dense matrix 110, the DMA engine interaction circuitry 250 causes execution of a DMA operation to accumulate the value(s) of the buffer into the buffer accumulator. (Block 655). In some examples, the accumulation of the value(s) of the buffer and the present value of the buffer accumulator is stored in the buffer accumulator. In some examples, the DMA engine interaction circuitry 250 provides a copy instruction to the DMA engine circuitry 230 with a flag set indicating that accumulation is to be performed while performing the copy operation. In response, the DMA engine circuitry 230 performs the requested copy (and accumulate) operation according to the process disclosed in connection with FIG. 5, above.

Once the DMA engine interaction circuitry 250 accumulates the buffer and the buffer accumulator, the matrix operation controller circuitry 240 determines whether additional non-zero values in the identified row still remain. (Block 660). When the matrix operation controller circuitry 240 determines that there are additional non-zero values still remaining (e.g., block 660 returns a result of YES), the operations of blocks 630-655 are repeated until no non-zero values remain in the row. (e.g., until block 660 returns a result of NO).

When no additional non-zero values remain in the row (e.g., block 660 returns a result of NO), the DMA engine interaction circuitry 250 causes execution of a DMA operation to accumulate the value of the buffer into the dense output matrix 115. (Block 665). In some examples, the DMA engine interaction circuitry 250 provides a copy instruction to the DMA engine circuitry 230 with a flag set indicating that accumulation is to be performed while performing the copy operation. In response, the DMA engine circuitry 230 performs the requested copy (and accumulate) operation according to the process disclosed in connection with FIG. 5, above. In some examples, the value(s) of the buffer is/are accumulated into a corresponding location (e.g., cell, index) of the dense output matrix 115. In some examples, buffer cells are accumulated into the corresponding cells of the dense output matrix. In some examples, the buffer can of any length (e.g., from length one to b, where b is a parameter chosen based on available temporary storage and/or DMA instruction overhead, if any).

Once the DMA engine interaction circuitry 250 accumulates the value(s) of the buffer into the dense output matrix 115, the matrix operation controller circuitry 240 determines whether there are additional rows in the sparse matrix 105 to process. (Block 670).

When the matrix operation controller circuitry 240 determines that there are more rows in the sparse matrix 105 to process (e.g., block 670 returns a result of YES), the operations of blocks 620 through 665 are repeated until no rows in the sparse matrix 105 remain to be processed. (e.g., until block 670 returns a result of NO). Once the matrix operation controller circuitry 240 determines that no additional rows are remaining to process in the sparse matrix 105 (e.g., block 670 returns a result of NO), the matrix operation controller circuitry 240 accesses the final dense output matrix 115 (Block 675), which includes the result of the SpMM operation. The example process 600 of FIG. 6 then terminates, but may be performed again to, for example, perform another SpMM operation.

As noted above, FIG. 6 illustrates an implementation of an SpMM operation using DMA. In some examples, additional and/or alternative approaches to implementing the SpMM might be used. For example, the operations of FIG. 6 operate on one row at a time. In some implementations, each of the rows are parallelized across different instances of the DMA circuitry 230 (e.g., to further accelerate compute performance). However, because each of those separate DMA circuitries are performing operations on separate rows of the sparse matrix, and those rows of the sparse matrix might have different amounts of non-zero data, there may be an uneven distribution of work (e.g., non-zeros from the sparse matrix) across threads during a parallel execution. FIG. 7 illustrates an implementation which iterates over non-zero values instead of rows/columns by fusing the two loops (of FIG. 6) of SpMM into one, while keeping track of row boundaries.

FIG. 7 is a flowchart representative of example machine readable instructions and/or example operations 700 that may be executed, instantiated, and/or performed by programmable circuitry to perform an SpMM operation. The example machine-readable instructions and/or the example operations 700 of FIG. 7 begin at block 705, at which the matrix operation controller circuitry 240 identifies a sparse matrix input (e.g., the sparse matrix 105). In some examples, the sparse matrix 105 has a size of N×K. The matrix operation controller circuitry 240 then identifies a dense matrix input (e.g., the dense matrix 110). (Block 710). In some examples, the dense matrix 110 has a size of K×M.

The matrix operation controller circuitry 240 identifies first and last non-zero elements in the sparse matrix 105. (Block 715). The matrix operation controller circuitry 240 causes initialization of a buffer accumulator. (Block 720). In some examples, the buffer accumulator is initialized with a size of M and with all zero values. In some examples, the size of M is equal to the number of elements of the dense matrix 110 in a second dimension (e.g., the M dimension of the dense matrix). In some examples, the buffer accumulator is populated with intermediate results (e.g., incremental throughout the SpMM operation) and can be allocated/accessed in a local storage (e.g., SRAM, scratchpad, cache, etc.).

The example matrix operation controller circuitry 240 identifies the next non-zero value of the sparse matrix 105 to obtain a row of the sparse matrix 105. (Block 725). In a first iteration of the loop defined by blocks 725 through 770, the next non-zero value is the first non-zero value of the sparse matrix 105. The example matrix operation controller circuitry 240 obtains the row index and the column index of the identified non-zero value. (Block 730). The matrix operation controller circuitry 240 then determines the value(s) to be manipulated using the identified row index and column index. (Block 735).

The example DMA engine interaction circuitry 250 then causes initialization of a buffer with the value(s) to be manipulated. (Block 740). In examples disclosed herein, the matrix operation controller circuitry 240 causes initialization of the buffer by sending an initialize instruction to the DMA engine circuitry 230, which then implements the initialization procedure disclosed in connection with FIG. 4. In some examples, instead of having the matrix operation controller circuitry 240 determine the value of the index to be manipulated, the DMA engine interaction circuitry 250 causes initialization of the buffer using the location at which the value is stored (e.g., causing the DMA engine circuitry 230 to read the value from the memory rather than providing the value to the DMA engine circuitry 230).

The matrix operation controller circuitry 240 determines whether a row boundary was passed (e.g., where one row ends and the next row begins in the sparse matrix 105) was passed. (Block 745). Such determination may be performed by comparing the current row index to a prior row index. In a first iteration of the loop defined by blocks 725 through 770, the row boundary may be considered to not have been passed.

When the matrix operation controller circuitry 240 determines that a row boundary was passed (e.g., block 745 returns a result of YES), the DMA engine interaction circuitry 250 causes execution of a DMA operation to accumulate the value of the buffer into the dense output matrix 115. (Block 750). Such accumulation completes the processing of the prior row. In some examples, the value(s) of the buffer is/are accumulated to a corresponding cell (e.g., index) of the dense output matrix 115. In examples disclosed herein, the matrix operation controller circuitry 240 causes execution of the DMA operation by sending a copy instruction to the DMA engine circuitry 230 with an accumulation flag set (e.g., indicating that an accumulation operation is to be performed). The DMA engine circuitry 230 then implements the accumulation procedure disclosed in connection with FIG. 5 based on the provided instruction.

After completing processing of the prior row, the matrix operation controller circuitry 240 reinitializes the buffer accumulator. (Block 755). In examples disclosed herein, the matrix operation controller circuitry 240 causes re-initialization of the buffer accumulator by sending an initialize instruction to the DMA engine circuitry 230, which then implements the initialization procedure disclosed in connection with FIG. 4.

After the matrix operation controller circuitry 240 reinitializes the buffer accumulator (Block 755) or if the matrix operation controller circuitry 240 determines that a row boundary was not reached (e.g., block 745 returns a result of NO), the DMA engine interaction circuitry 250 causes execution of a DMA operation to multiply the value(s) of the buffer with the corresponding row of the dense matrix 110. (Block 760). In some examples, the execution of the DMA operation multiplies the value(s) of the buffer with a corresponding row of the dense matrix 110. In some examples, the result of the DMA operation is stored in the buffer. In examples disclosed herein, the matrix operation controller circuitry 240 causes execution of the DMA operation by sending a copy instruction to the DMA engine circuitry 230 with a flag set indicating that multiplication is to be performed. The DMA engine circuitry 230 then implements the multiplication procedure disclosed in connection with FIG. 5 based on the provided instruction.

The DMA engine interaction circuitry 250 then causes execution of a DMA operation to accumulate the value(s) of the buffer into the buffer accumulator. (Block 765). In some examples, the accumulation of these values (e.g., the prior value of the buffer accumulator and the buffer) is stored in the buffer accumulator. In examples disclosed herein, the matrix operation controller circuitry 240 causes execution of the DMA operation by sending a copy instruction to the DMA engine circuitry 230 with a flag set indicating that accumulation is to be performed. The DMA engine circuitry 230 then implements the accumulation procedure disclosed in connection with FIG. 5 based on the provided instruction.

The example matrix operation controller circuitry 240 determines whether the last non-zero element has been processed. (Block 770). If additional non-zero values exist to be processed (e.g., block 770 returns a result of NO), control proceeds to block 725, where the operations of blocks 725 through 770 are repeated until all non-zero elements have been processed.

When the matrix operation controller circuitry 240 determines that the last non-zero element has been processed (e.g., block 770 returns a result of YES), the DMA engine interaction circuitry 250 causes execution of a DMA operation to accumulate the value(s) of the buffer into the dense output matrix 115. (Block 775). This completes processing of the final row. In some examples, the accumulating of the value(s) of the buffer is accumulated to a corresponding cell (e.g., index) of the dense output matrix 115. In examples disclosed herein, the matrix operation controller circuitry 240 causes execution of the DMA operation by sending a copy instruction to the DMA engine circuitry 230 with no flags set (e.g., indicating that only a copy operation is to be performed). The DMA engine circuitry 230 then implements the copy procedure disclosed in connection with FIG. 5 based on the provided instruction.

The example matrix operation controller circuitry 240 accesses the final dense output matrix 115 (Block 780), which includes the result of the SpMM operation. The example process 700 of FIG. 7 then terminates, but may be performed again to, for example, perform another SpMM operation.

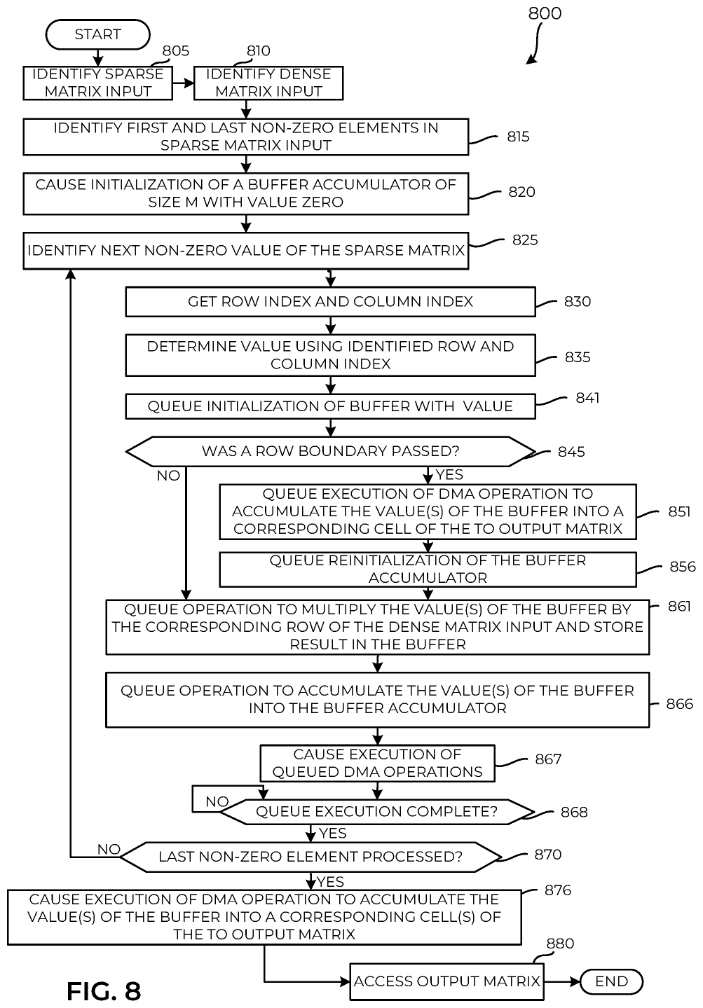

In the illustrated example of FIG. 7, each DMA operation is sent to the DMA engine circuitry 230 individually. Such an approach results in operations where the DMA engine circuitry 230 completes an operation, and then must wait for an instruction to perform the next operation. In some examples, such DMA operations may be chained (e.g., batched, grouped, queued, etc.) together to reduce an amount of time that the DMA engine circuitry 230 waits for subsequent operations from the DMA engine interaction circuitry 250. FIG. 8 illustrates an alternative approach to the example of FIG. 7, which utilizes DMA chaining. Such an approach enables creating/initializing a sequence of DMA instructions that follow strict sequential order without going back/forth to the compute circuitry 210. In some examples, the DMA engine interaction circuitry 250 provides an instruction that the DMA engine circuitry 230 is to begin storing a chain (e.g., a queue) of DMA engine instructions. Upon indication that creation of a chain is complete, the DMA engine 230 may then execute the operations in the chain and provide an indication that the operation(s) are complete. In some examples, the DMA engine circuitry 230 does not wait for the indication that chain is complete to trigger execution of the chain, but instead begins execution of such DMA operations as the chain is being constructed.

FIG. 8 is a flowchart representative of example machine readable instructions and/or example operations 800 that may be executed, instantiated, and/or performed by programmable circuitry to perform an SpMM operation. The example machine-readable instructions and/or the example operations 800 of FIG. 8 begin at block 805, at which the matrix operation controller circuitry 240 identifies a sparse matrix input (e.g., the sparse matrix 105). In some examples, the sparse matrix 105 has a size of N×K. The matrix operation controller circuitry 240 then identifies a dense matrix input (e.g., the dense matrix 110). (Block 810). In some examples, the dense matrix 110 has a size of K×M.

The matrix operation controller circuitry 240 identifies first and last non-zero elements in the sparse matrix 105. (Block 815). The matrix operation controller circuitry 240 causes initialization of a buffer accumulator. (Block 820). In some examples, the buffer accumulator is initialized with a size of M and with all zero values. In some examples, the size of M is equal to the number of elements of the dense matrix 110 in a second dimension (e.g., the M dimension of the dense matrix). In some examples, the buffer accumulator is populated with intermediate results (e.g., incremental throughout the SpMM operation) and can be allocated/accessed in a local storage (e.g., SRAM, scratchpad, cache, etc.).

The example matrix operation controller circuitry 240 identifies the next non-zero value of the sparse matrix 105 to obtain a row of the sparse matrix 105. (Block 825). In a first iteration of the loop defined by blocks 825 through 870, the next non-zero value is the first non-zero value of the sparse matrix 105. The example matrix operation controller circuitry 240 obtains the row index and the column index of the identified non-zero value. (Block 830). The matrix operation controller circuitry 240 then determines the value to be manipulated using the identified row index and column index. (Block 835).

The example matrix operation controller circuitry 240 then queues initialization of a buffer with the value(s) of the index to be manipulated. (Block 841). In examples disclosed herein, the matrix operation controller circuitry 240 causes queuing of the initialization of the buffer by sending an queue instruction to the DMA engine circuitry 230, which then adds the initialization instruction to the instruction queue 330. In some examples, instead of having the matrix operation controller circuitry 240 determine the value(s) of the index to be manipulated, the DMA engine interaction circuitry 250 may cause initialization of the buffer using the location at which the value(s) is/are stored (e.g., causing the DMA engine circuitry 230 to read the value(s) from the memory rather than providing the value(s) to the DMA engine circuitry 230).

The matrix operation controller circuitry 240 determines whether a row boundary was passed (e.g., where one row ends and the next row begins in the sparse matrix 105) was passed. (Block 845). Such determination may be performed by comparing the current row index to a prior row index. In a first iteration of the loop defined by blocks 825 through 870, the row boundary may be considered to not have been passed.

When the matrix operation controller circuitry 240 determines that a row boundary was passed (e.g., block 745 returns a result of YES), the DMA engine interaction circuitry 250 queues execution of a DMA operation to accumulate the value(s) of the buffer into the dense output matrix 115. (Block 851). Such accumulation, once executed, completes the processing of the prior row. In some examples, the accumulating of the value of the buffer is accumulated to a corresponding cell (e.g., index) of the dense output matrix 115. In examples disclosed herein, the matrix operation controller circuitry 240 causes queuing of the execution of the DMA operation by sending a queue instruction to the DMA engine circuitry 230.

After completing processing of the prior row, the matrix operation controller circuitry 240 reinitializes the buffer accumulator. (Block 856). In examples disclosed herein, the matrix operation controller circuitry 240 queues re-initialization of the buffer accumulator by sending an queue instruction to the DMA engine circuitry 230, which causes storage of the corresponding instruction to be executed in the instruction queue 330.

After the matrix operation controller circuitry 240 queues reinitialization of the buffer accumulator (Block 856) or if the matrix operation controller circuitry 240 determines that a row boundary was not passed (e.g., block 845 returns a result of NO), the DMA engine interaction circuitry 250 queues execution of a DMA operation to multiply the value(s) of the buffer with the dense matrix 110. (Block 861). In some examples, the queued execution of the DMA operation will multiply the value(s) of the buffer with a corresponding row of the dense matrix 110. In some examples, the result of the DMA operation is stored in the buffer. In examples disclosed herein, the matrix operation controller circuitry 240 queues the execution of the DMA operation by sending a queue instruction to the DMA engine circuitry 230, which causes storage of the corresponding instruction to be executed in the instruction queue 330.

The DMA engine interaction circuitry 250 then queues execution of a DMA operation to accumulate the value(s) of the buffer into the buffer accumulator. (Block 866). In some examples, the accumulation of these values (e.g., the prior value of the buffer accumulator and the buffer) is stored in the buffer accumulator. In examples disclosed herein, the matrix operation controller circuitry 240 queues execution of the DMA operation by sending a queue instruction to the DMA engine circuitry 230, which causes storage of the corresponding instruction to be executed in the instruction queue 330.

The example DMA engine interaction circuitry 250 then causes execution of the DMA operations. (Block 867). As a result, the DMA engine circuitry 230 executes, in order, the queued instructions. Upon completion of the execution of the queued instructions, the DMA engine circuitry 230 provides an indication that such the execution of the queued instructions is complete. The matrix operation controller circuitry 240 waits for such an indication. (Block 868). When the matrix operation controller circuitry 240 determines that the queue execution is not complete (e.g., block 868 returns a result of NO), the matrix operation controller circuitry 240 continues to wait for such an indication.

When the matrix operation controller circuitry 240 determines that the queue execution is complete (e.g., block 868 returns a result of YES), the matrix operation controller circuitry 240 determines whether the last non-zero element has been processed. (Block 870). If additional non-zero values exist to be processed (e.g., block 870 returns a result of NO), control proceeds to block 825, where the operations of blocks 825 through 870 are repeated until all non-zero elements have been processed.

When the matrix operation controller circuitry 240 determines that the last non-zero element has been processed (e.g., block 870 returns a result of YES), the DMA engine interaction circuitry 250 causes execution of a DMA operation to accumulate the value of the buffer into the dense output matrix 115. (Block 876). This completes processing of the final row. In some examples, the accumulating of the value of the buffer is accumulated to a corresponding cell (e.g., index) of the dense output matrix 115. In examples disclosed herein, the matrix operation controller circuitry 240 causes execution of the DMA operation by sending a copy instruction to the DMA engine circuitry 230 with no flags set (e.g., indicating that only a copy operation is to be performed). The DMA engine circuitry 230 then implements the copy procedure disclosed in connection with FIG. 5 based on the provided instruction.

The example matrix operation controller circuitry 240 accesses the final dense output matrix 115 (Block 880), which includes the result of the SpMM operation. The example process 800 of FIG. 8 then terminates, but may be performed again to, for example, perform another SpMM operation.

FIG. 9 is a flowchart representative of example machine readable instructions and/or example operations 900 that may be executed, instantiated, and/or performed by programmable circuitry to execute a DMA operation(s) that has been queued. The example machine-readable instructions and/or the example operations 900 of FIG. 9 begin at block 910, at which the DMA instruction executor circuitry 360 identifies the operation in the queue to be executed. The DMA instruction executor circuitry 360 then identifies a type of the operation to be executed. (Block 920). If the instruction is an initialization operation (e.g., block 920 returns a result of INITIALIZATION), the DMA instruction executor circuitry 360 performs the initialization operation 400 of FIG. 4. (Block 400).

If the DMA instruction executor circuitry 360 determines that the type of the operation is a copy operation (e.g., block 920 returns a result of COPY), the DMA instruction executor circuitry 360 performs the copy operation 500 of FIG. 5. (Block 500). In some examples, additional flags may be set with respect to the copy operation indicating that multiplication and/or accumulation is to be performed. While in the illustrated example of FIG. 9, two different types of operations are supported, many additional types of operations may additionally or alternatively be supported. In some examples, upon completion of the instruction, the DMA instruction executor circuitry 360 removes the executed instruction from the queue. In some other examples, the DMA instruction executor circuitry 360 may increment an index or other variable indicating which instructions have already been executed and/or which is the next instruction to be executed.

When the DMA instruction executor circuitry 360 performs either the initialization operation 400 of FIG. 4 or the copy operation 500 of FIG. 5, the DMA instruction executor circuitry 360 determines whether any additional operations are to be performed by inspecting the instruction queue 330. (Block 940). When the DMA instruction executor circuitry 360 determines that there are additional operations to perform (e.g., block 940 returns a result of YES), the operations of blocks 910 through 940 are repeated.

When the DMA instruction executor circuitry 360 determines that no additional operations remain to be performed (e.g., block 940 returns a result of NO), then the DMA instruction interface 320 provides an indication of completion of the execution of the queued operations. (Block 950). In some examples, while performing the loop defined by blocks 910 through 940, the DMA instruction executor circuitry 360 does not provide any information to the DMA engine interaction circuitry 250. That is, no indication(s) that intermediate operations within the queue have been completed is sent to the DMA engine interaction circuitry 250. Instead, a single indication that the execution of the queued instructions is provided at block 950. The example process 900 of FIG. 9 then terminates, but may be re-executed to, for example, process a subsequent queue of instructions.

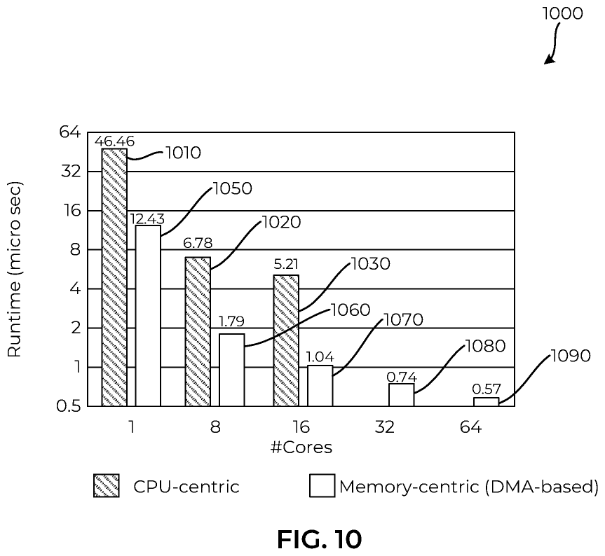

FIG. 10 is a graph 1000 illustrating performance benefits of implementing SpMM operations using direct memory access. The example graph 1000 illustrates execution times of a deep learning recommendation model (DLRM) using various approaches for SpMM. In the illustrated example of FIG. 10, the horizontal axis is represented using a logarithmic scale. A first column 1010 indicates that a CPU executing the DLRM process locally using one CPU core completed the operation in 46.46 microseconds. A second column 1020 indicates that the CPU executing the DLRM process locally using eight CPU cores completed the operation in 6.78 microseconds. A third column 1030 indicates that the CPU executing the DLRM process locally using sixteen CPU cores completed the operation in 5.21 microseconds. Execution and/or simulation of use of thirty two and/or sixty four CPU cores was not feasible, but projections indicate that performance leveled off at approximately five milliseconds.

In contrast, a fourth column 1050 indicates that the CPU executing the DLRM process while using the example techniques disclosed in this application (e.g., using DMA engine circuitry to perform DMA operations) using a single instance of DMA engine circuitry completed the DLRM process in 12.43 microseconds. A fifth column 1060 indicates that the CPU executing the DLRM process using eight instances of DMA engine circuitry completed the DLRM process in 1.79 microseconds. A sixth column 1070 indicates that the CPU executing the DLRM process using sixteen instances of DMA engine circuitry completed the DLRM process in 1.04 microseconds. A seventh column 1080 indicates that the CPU executing the DLRM process using thirty two instances of DMA engine circuitry completed the DLRM process in 0.74 microseconds. An eighth column 1090 indicates that the CPU executing the DLRM process using sixty four instances of DMA engine circuitry completed the DLRM process in 0.57 microseconds. Such performance information indicates that there is a significant reduction in the amount of time required to perform DLRM processes using the approaches for executing SpMM disclosed herein.

FIG. 11 is a block diagram of an example programmable circuitry platform 1100 structured to execute and/or instantiate the example machine-readable instructions and/or the example operations of FIGS. 4, 5, 6, 7, 8, and/or 9 to implement the compute device 200 of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example matrix operation controller circuitry 240 and the DMA engine interaction circuitry 250. In examples disclosed herein, the example DMA engine circuitry 230 communicates with the memory 1114, 1116 via the bus 1118.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 4, 5, 6, 7, 8, and/or 9, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 4, 5, 6, 7, 8, and/or 9 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 4, 5, 6, 7, 8, and/or 9.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 4, 5, 6, 7, 8, and/or 9 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4, 5, 6, 7, 8, and/or 9. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5, 6, 7, 8, and/or 9. As such, the FPGA circuitry 1300 may be configured and/or structured to effectively instantiate some or all of the operations/functions corresponding to the machine readable instructions of the flowchart(s) of FIGS. 4, 5, 6, 7, 8, and/or 9 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 4, 5, 6, 7, 8, and/or 9 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 4, 5, 6, 7, 8, and/or 9 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 4, 5, 6, 7, 8, and/or 9 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 4, 5, 6, 7, 8, and/or 9, and/or an ASIC may be configured and/or structured to perform third operation(s)/function(s) corresponding to a third portion of the machine readable instructions represented by the flowcharts of FIGS. 4, 5, 6, 7, 8, and/or 9.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

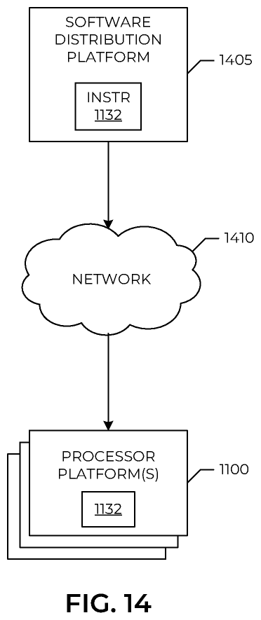

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 4, 5, 6, 7, 8, and/or 9, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 4, 5, 6, 7, 8, and/or 9, may be downloaded to the example programmable circuitry platform 1100, which is to execute the machine readable instructions 1132 to implement the compute device 200. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that enable improved performance for execution of SpMM operations using direct memory access. In some examples, DMA chaining and/or queueing of operations additionally improves such performance. Disclosed systems, apparatus, articles of manufacture, and methods improve the efficiency of using a computing device by reducing the amount of time needed to perform SpMM operations, and offloading of such operations to DMA engine circuitry. Such approaches free the CPU and/or other compute circuitry to perform other operations. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to perform sparse matrix time dense matrix operations are disclosed herein. Further examples and combinations thereof include the following:

Example 1 includes an apparatus to perform a sparse matrix times dense matrix operation, the apparatus comprising interface circuitry to access a sparse matrix and a dense matrix stored in a memory, computer readable instructions, and programmable circuitry to instantiate matrix operation controller circuitry to control execution of the sparse matrix times dense matrix operation using the sparse matrix and the dense matrix, and Direct Memory Access (DMA) engine interaction circuitry to transmit a plurality of instructions to execute the sparse matrix times dense matrix operation to DMA engine circuitry, the plurality of instructions to cause the DMA engine circuitry to create an output matrix in the memory, wherein the matrix operation controller is to access the output matrix from the memory.

Example 2 includes the apparatus of example 1, wherein the plurality of instructions includes a copy instruction to cause the DMA engine circuitry to perform a copy operation, the copy instruction including a flag to identify whether an additional operation is to be performed in connection with performance of the copy operation.

Example 3 includes the apparatus of example 2, wherein the additional operation is a multiply operation.

Example 4 includes the apparatus of example 2, wherein the additional operation is an accumulate operation.

Example 5 includes the apparatus of example 1, wherein the DMA engine interaction circuitry is to cause the DMA engine circuitry to chain execution of a portion of the plurality of instructions.

Example 6 includes the apparatus of example 1, further including the DMA engine circuitry, wherein the DMA engine circuitry is to access a first element of the sparse matrix and a second element of the dense matrix from the memory without the programmable circuitry accessing the first element of the sparse matrix or the second element of the dense matrix from the memory.

Example 7 includes the apparatus of example 1, wherein the DMA engine circuitry further includes local buffer circuitry to store a buffer and a buffer accumulator to be used while performing the sparse matrix time dense matrix operation.

Example 8 includes the apparatus of example 7, wherein the plurality of instructions includes an initialization instruction to cause the DMA engine circuitry to initialize a value in the local buffer circuitry.

Example 9 includes the apparatus of example 1, wherein the programmable circuitry includes one or more of at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

Example 10 includes a non-transitory machine readable storage medium comprising instructions to cause programmable circuitry to at least control execution of a sparse matrix times dense matrix operation using a sparse matrix and a dense matrix stored in memory, and transmit a plurality of instructions to execute the sparse matrix times dense matrix operation to DMA engine circuitry, the plurality of instructions to cause the DMA engine circuitry to create an output matrix in the memory, the creation of the output matrix in the memory performed without the programmable circuitry computing the output matrix.

Example 11 includes the non-transitory machine readable storage medium of example 10, wherein the plurality of instructions includes a copy instruction to cause the DMA engine to perform a copy operation, the copy instruction including a flag to identify whether an additional operation is to be performed in connection with performance of the copy operation.

Example 12 includes the non-transitory machine readable storage medium of example 11, wherein the additional operation is a multiply operation.

Example 13 includes the non-transitory machine readable storage medium of example 11, wherein the additional operation is an accumulate operation.

Example 14 includes the non-transitory machine readable storage medium of example 10, wherein the instructions cause the programmable circuitry to cause the DMA engine circuitry to chain execution of a portion of the plurality of instructions.

Example 15 includes the non-transitory machine readable storage medium of example 10, wherein the plurality of instructions includes an initialization instruction to cause the DMA engine circuitry to initialize a value in a buffer of the DMA engine circuitry.

Example 16 includes a method for performance of a sparse matrix time dense matrix operation, the method comprising controlling execution of the sparse matrix times dense matrix operation using a sparse matrix and a dense matrix stored in memory, and providing, but executing an instruction with at least one processor, a plurality of instructions to execute the sparse matrix times dense matrix operation to DMA engine circuitry, the plurality of instructions to cause the DMA engine circuitry to create an output matrix in the memory, the creation of the output matrix in the memory performed without the at least one processor computing the output matrix.

Example 17 includes the method of example 16, wherein the plurality of instructions includes a copy instruction to cause the DMA engine circuitry to perform a copy operation, the copy instruction including a flag to identify whether an additional operation is to be performed in connection with performance of the copy operation.

Example 18 includes the method of example 17, wherein the additional operation is a multiply operation.

Example 19 includes the method of example 17, wherein the additional operation is an accumulate operation.

Example 20 includes the method of example 16, wherein the instructions cause the programmable circuitry to cause the DMA engine circuitry to chain execution of a portion of the plurality of instructions.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to perform a sparse matrix times dense matrix operation, the apparatus comprising:
interface circuitry to access a sparse matrix and a dense matrix stored in a memory;
computer readable instructions; and
programmable circuitry to instantiate:
matrix operation controller circuitry to control execution of the sparse matrix times dense matrix operation using the sparse matrix and the dense matrix; and
Direct Memory Access (DMA) engine interaction circuitry to transmit a plurality of instructions to execute the sparse matrix times dense matrix operation to DMA engine circuitry, the plurality of instructions to cause the DMA engine circuitry to create an output matrix in the memory, wherein the matrix operation controller is to access the output matrix from the memory.

2. The apparatus of claim 1, wherein the plurality of instructions includes a copy instruction to cause the DMA engine circuitry to perform a copy operation, the copy instruction including a flag to identify whether an additional operation is to be performed in connection with performance of the copy operation.

3. The apparatus of claim 2, wherein the additional operation is a multiply operation.

4. The apparatus of claim 2, wherein the additional operation is an accumulate operation.

5. The apparatus of claim 1, wherein the DMA engine interaction circuitry is to cause the DMA engine circuitry to chain execution of a portion of the plurality of instructions.

6. The apparatus of claim 1, further including the DMA engine circuitry, wherein the DMA engine circuitry is to access a first element of the sparse matrix and a second element of the dense matrix from the memory without the programmable circuitry accessing the first element of the sparse matrix or the second element of the dense matrix from the memory.

7. The apparatus of claim 1, wherein the DMA engine circuitry further includes local buffer circuitry to store a buffer and a buffer accumulator to be used while performing the sparse matrix time dense matrix operation.

8. The apparatus of claim 7, wherein the plurality of instructions includes an initialization instruction to cause the DMA engine circuitry to initialize a value in the local buffer circuitry.

9. The apparatus of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

10. A non-transitory machine readable storage medium comprising instructions to cause programmable circuitry to at least:
control execution of a sparse matrix times dense matrix operation using a sparse matrix and a dense matrix stored in memory; and
transmit a plurality of instructions to execute the sparse matrix times dense matrix operation to DMA engine circuitry, the plurality of instructions to cause the DMA engine circuitry to create an output matrix in the memory, the creation of the output matrix in the memory performed without the programmable circuitry computing the output matrix.

11. The non-transitory machine readable storage medium of claim 10, wherein the plurality of instructions includes a copy instruction to cause the DMA engine to perform a copy operation, the copy instruction including a flag to identify whether an additional operation is to be performed in connection with performance of the copy operation.

12. The non-transitory machine readable storage medium of claim 11, wherein the additional operation is a multiply operation.

13. The non-transitory machine readable storage medium of claim 11, wherein the additional operation is an accumulate operation.

14. The non-transitory machine readable storage medium of claim 10, wherein the instructions cause the programmable circuitry to cause the DMA engine circuitry to chain execution of a portion of the plurality of instructions.

15. The non-transitory machine readable storage medium of claim 10, wherein the plurality of instructions includes an initialization instruction to cause the DMA engine circuitry to initialize a value in a buffer of the DMA engine circuitry.

16. A method for performance of a sparse matrix time dense matrix operation, the method comprising:
controlling execution of the sparse matrix times dense matrix operation using a sparse matrix and a dense matrix stored in memory; and
transmitting, by executing an instruction with at least one processor, a plurality of instructions to execute the sparse matrix times dense matrix operation to DMA engine circuitry, the plurality of instructions to cause the DMA engine circuitry to create an output matrix in the memory, the creation of the output matrix in the memory performed without the at least one processor computing the output matrix.

17. The method of claim 16, wherein the plurality of instructions includes a copy instruction to cause the DMA engine circuitry to perform a copy operation, the copy instruction including a flag to identify whether an additional operation is to be performed in connection with performance of the copy operation.

18. The method of claim 17, wherein the additional operation is a multiply operation.

19. The method of claim 17, wherein the additional operation is an accumulate operation.

20. The method of claim 16, wherein the instructions cause the programmable circuitry to cause the DMA engine circuitry to chain execution of a portion of the plurality of instructions.
